(19) United States
(12) Patent Application Publication
(10) Pub. No.: US 2025/0342365 A1
(43) Pub. Date: Nov. 6, 2025

(54) KNOWLEDGE GRAPH-ENHANCED AI COPILOT PLATFORM FOR INTELLIGENT IDENTITY SECURITY GOVERNANCE AND LIFECYCLE MANAGEMENT

(71) Applicants: Subramanian Rama, Irving, TX (US); Dalwinderjeet Grewal, Cedar Park, TX (US); Anish Raghavendra, Bangalore (IN); Suraj Ranganath, Bangalore (IN)

(72) Inventors: Subramanian Rama, Irving, TX (US); Dalwinderjeet Grewal, Cedar Park, TX (US); Anish Raghavendra, Bangalore (IN); Suraj Ranganath, Bangalore (IN)

(21) Appl. No.: 19/055,635

(22) Filed: Feb. 18, 2025

Related U.S. Application Data
(60) Provisional application No. 63/641,397, filed on May 1, 2024.

(51) Int. Cl. G06N 5/02

(52) U.S. Cl. CPC G06N 5/02

(57) ABSTRACT

A copilot platform for identity security governance and lifecycle management, used for capturing the complexity and relatedness of identity security data. The copilot platform integrates Knowledge Graphs and Large Language Model to enhance data exploration and understanding. The LLM converts natural language queries into Cypher queries, enabling interaction with graph databases. The copilot platform includes query annotation to facilitate LLM for recognized entities and for enduring necessary correctness to those entities if required and that increases overall accuracy of the Copilot. The LLMs and data metrics are used to summarize the data for the end user. The copilot platform uses an AI system for interacting with a user to learn about the state of user identity security, take action when required and, given the complexity of IGA data, including information on differentiated dashboards and custom reports, for allowing the user to visualize and manage the information effectively.

### CROSS-REFERENCE TO RELATED APPLICATIONS

This application is a Utility Patent application claiming priority to U.S. Provisional Patent Application Ser. No. 63/641,397, filed on May 1, 2024, which is incorporated by reference herein in its entirety.

### COPYRIGHT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1) Field of the Invention

The invention relates to the field of identity security governance and lifecycle management, and more specifically to a knowledge graph-enhanced AI copilot platform for intelligent identity security governance and lifecycle management.

### 2) Description of Related Art

One problem with identity governance and administration (IGA) is that identity governance and administration involves managing complex and multi-faceted data. For example, an employee can have multiple identities, and these identities might have access to various resources in various applications via memberships or connections. These identities are not just static entities; they include critical insights such as whether they have access to privileged connections & permissions, sensitive resources, if they stand out as outliers, or if they are over-entitled. Similarly, employees, applications, connections, and resources come with their own insights, adding layers of complexity. The highly relational nature of this data makes rigid web interfaces restrictive when users attempt to explore it in more detail. Accessing and extracting meaningful information from this kind of data often requires a strong grasp of specific query languages. This creates a significant barrier for users who might not be familiar with these technical languages but still need to make data-driven decisions. To bridge this gap, what is needed is an artificial intelligence (AI) system that a user can interact with to learn more about the state of their identity security and take action when required. Additionally, given the complexity of IGA data, there's a clear need for differentiated dashboards and custom reports to allow users to visualize and manage this information effectively.

### BRIEF SUMMARY OF THE INVENTION

The knowledge graph-enhanced AI copilot for intelligent identity security governance and lifecycle management, hereinafter referred to as the copilot system, allows end users to get answers to their queries on their organization's identity security posture and convert this information into reports and dashboards. Most importantly, the goal is to provide an investigation system accessible to risk managers, reviewers and administrators in the company, enabling them to explore and analyze their data. This system will allow users to ask a series of questions, identify potential security issues, and verify that data is accurate and compliant before an audit. This is essential for maintaining data integrity and ensuring robust security throughout the organization.

On aspect of the invention is directed to a platform for comprehending the vast troves of identity data and for empowering users to make intelligent, well-informed decisions in proactively manage identity risks. The platform includes an identity knowledge graph for enabling a user to visualize relationships between identities of the user, connections, resources and applications. The identity knowledge graph includes a plurality of nodes wherein the plurality of nodes are selected from a group including, Identity, Employee, Application, Connection, Resource, Permission, EmployeeInsight, Identity Insight, ConnectionInsight, PermissionInsight, ResourceInsight, RBACInsight, Campaign, Request, RequestReview, Review, Role, Purposes and Constraints. The insights are intelligently routed, assessed, and remediated based on AI playbooks to meet identity and access lifecycle, technology compliance, and risk management needs. The platform includes a system leveraging a knowledge graph and Large Language Models (LLMs) wherein access data is structured within the knowledge graph as nodes and relationships.

Users may ask questions in natural language wherein the questions are transformed into graph-compatible queries through the combined use of Retrieval-Augmented Generation (RAG) and LLMs wherein RAG retrieves relevant context from a query dataset, ensuring the LLM generates an accurate and contextually appropriate query based on the user's input and the knowledge graph schema. The query may be used to retrieve the necessary data, which is summarized for the end user, making the data easy to interpret and act upon.

Another aspect of the invention is directed to a copilot for identity security. The copilot has AI-assistance. The copilot included a custom, fine-tuned large language model (LLM) converts natural language to graph queries, wherein a knowledge graph schema of the platform provides the LLM information on the structure nodes, relations and attributes in the knowledge graphs so that queries can be formed adhering to the graph structure. Based on the question, the platform retrieves similar question and graph query pairs based on cosine similarity. The copilot includes an error correction module whereby errors in graph query execution are fed back to the model with error messages to retry generation. The copilot includes a human feedback module whereby correctness of output is collected to improve LLM generation and an entity tagging module whereby entities are tagged using fuzzy search to recognize known entities and their types based on the knowledge graph. The copilot includes a summary module where, based on the data fetched to answer a given question, the platform generates a summary without passing personally identifiable information to the LLM. The insights like ‘Terminated’, ‘Manager’, ‘Privileged Permission’, ‘Privileged Connection’, ‘SoD’, ‘Overentitled’, ‘Outlier’, ‘MFA Missing’, ‘Unused Credentials’, ‘Data Exfiltration’, ‘Admin IAM Policy’, ‘Root Account Access’ and ‘Stale Access Keys’ may be implemented with varying severity levels. They are derived from HRIS information, user defined rules, RBAC, and application specific security findings that are obtained from their respective APIs. Based on the insights, the platform uses an LLM to explain the existence of the insight along with the steps the user could take to remediate. These insights are applied on entities such as employee, identity, connection, permission, resource and role. Using the generated query, the desired results may be obtained from the knowledge graph and based on the results, users can ask follow-up informational questions. Follow up questions that the user can ask to deepen their analysis are also suggested based on the context of the conversation using the suggestions module. The user may choose to perform analysis such as finding similar nodes for migration of employees between teams and link prediction to find missing connections, which is achieved by leveraging graph neural networks. Actions such as creating access review campaigns, provisioning and de-provisioning of users using Purposes may be performed as well by simply utilizing natural language. Purposes are predefined sets of connections and permissions that can be assigned to identities for provisioning and deprovisioning. Before assigning them to identities, a check is conducted to ensure they comply with all constraints, thereby maintaining alignment with the organization's security policies. The copilot also includes pre-defined use cases, consisting of a series of sequential questions, which users can follow to comprehensively analyze specific aspects of their organization's identity security posture. The copilot utilizes the relational and connected nature of knowledge graphs and may employ AI agents to allow clients to interact, analyze and act on the client identity security data using natural language. The copilot may include integrating knowledge graphs, the system provides flexibility in structure, scalability, easy interpretation, and eliminates redundancy. The copilot may utilize the agentic behavior of large language models to break down a complex question into a series of subtasks. In the summary module, insights like ‘Terminated’, ‘Manager’, ‘Privileged Permission’, ‘Privileged Connection’, ‘SoD’, ‘Overentitled’, ‘Outlier’, ‘MFA Missing’, ‘Unused Credentials’, ‘Data Exfiltration’, ‘Admin IAM Policy’, ‘Root Account Access’ and ‘Stale Access Keys’ are fetched along with the data at the resource, permission, role, connection, identity and employee level and is brought to the attention of the user. The insights may be implemented based on a combination of filters and based on the information, the platform uses an LLM to explain the existence of the insight along with the steps the user could take to remediate it. The copilot for identity security may include using the generated query to obtain results from the knowledge graph wherein, based on the results, users can ask follow-up informational questions and also provided a choice to perform analysis, like finding similar nodes for migration of employees between teams and link prediction to find missing connections. The graph neural networks may be used and actions like creating access requests, access review campaigns, provisioning and de-provisioning of users using purposes can be performed using natural language.

Another aspect of the invention is directed to a copilot platform for identity security governance and lifecycle management. The copilot platform is used for capturing the complexity and relatedness of identity security data. The copilot platform integrates Knowledge Graphs and a Large Language Model (LLM) to enhance data exploration and understanding. The LLM converts natural language queries into Cypher queries, enabling seamless interaction with graph databases. Query annotation is used to facilitate LLM for recognized entities and for enduring necessary correctness to those entities if required and that increases overall accuracy of the copilot. The LLMs and data metrics are used to summarize the data for the end user. The copilot uses an AI system for interacting with a user wherein the AI system can interact with the user to learn more about the state of user identity security and take action when required and, given the complexity of IGA data, including information on differentiated dashboards and custom reports for allowing the user to visualize and manage the information effectively.

The platform as described herein is an intelligent identity security and lifecycle platform including an identity knowledge graph which enables users to visualize relationships between identities, connections, resources and applications. These insights are then intelligently routed, assessed, and remediated based on AI playbooks to meet identity and access lifecycle, technology compliance, and risk management needs.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 shows a flowchart for use of the platform for users to manage and understand access within an organization;

FIG. 2 shows a structured representation of an identity intelligence graph according to the present invention;

FIG. 3 shows a flowchart which includes pre-processing to develop a dataset containing user queries in natural language paired with their corresponding cypher queries.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

Acronyms as used herein include Multi-Factor Authentication (MFA), role based access control (RBAC), segregation of Duties (SoD), Identity Access Management (IAM), business to business (B2B), human resource Information System (HRIS), application programming interface (API), and Identity Governance and Administration (IGA).

Knowledge Graphs which may be used include an identity knowledge graph by BalkinID.

The knowledge graph as used in the specification is an identity knowledge graph although the platform would work with other applications.

As a general term, artificial intelligence (AI) copilots are part of a digital technology landscape which can provide assistance in tasks such as drafting an email, answering specific questions, guiding a user through a complex B2B sales process, create images, and the like. The copilot herein refers to a knowledge graph-enhanced AI copilot which is used for intelligent identity security governance and lifecycle management.

The present invention is an advanced, AI-powered copilot specifically designed for identity security, utilizing the relational and connected nature of knowledge graphs. This copilot employs AI agents to allow clients to interact, analyze and act on their identity security data using natural language. By integrating knowledge graphs, the system will provide flexibility in structure, scalability, easy interpretation, and can eliminate redundancy, with fast query speeds.

The present invention utilizes the agentic behavior of large language models to break down a complex question into a series of subtasks. The platform is a custom, fine-tuned large language model to convert natural language to graph queries. The following methods are utilized:
1. Knowledge Graph Schema: The platform provides the large language model (LLM) information on the structure nodes, relations and attributes in the graph so that queries can be formed adhering to the graph structure.
2. Retrieval Augmented Examples: Based on the question, the platform retrieves similar question and graph query pairs based on cosine similarity. For certain questions that require descriptive answers, context is fetched as chunks of text from the knowledge base based on cosine similarity and subsequent reranking.
3. Error Correction: Errors in graph query execution are fed back to the model with error messages to retry generation.
4. Human Feedback: Feedback on correctness of output is collected to improve LLM generation.
5. Entity Tagging: Entities are tagged using fuzzy search to recognize known entities and their types based on the knowledge graph.
6. Summary: Based on the data fetched to answer a given question, the platform generates a summary without passing personally identifiable information to the LLM. More importantly, insights like ‘Terminated’, ‘Manager’, ‘Privileged Permission’, ‘Privileged Connection’, ‘SoD’, ‘Overentitled’, ‘Outlier’, ‘MFA Missing’, ‘Unused Credentials’, ‘Data Exfiltration’, ‘Admin IAM Policy’, ‘Root Account Access’ and ‘Stale Access Keys’ are fetched along with the data at the resource, permission, role, connection, identity and employee level. This is brought to the attention of users through the summary.
7. Explanation and Remediation of Insights: Insights like ‘Terminated’, ‘Manager’, ‘Privileged Permission’, ‘Privileged Connection’, ‘SoD’, ‘Overentitled’, ‘Outlier’, ‘MFA Missing’, ‘Unused Credentials’, ‘Data Exfiltration’, ‘Admin IAM Policy’, ‘Root Account Access’ and ‘Stale Access Keys’ are implemented with varying severity levels. They are derived from HRIS information, user defined rules, RBAC, and application specific security findings that are obtained from their respective APIs. Based on the insights, the platform uses an LLM to explain the existence of the insight along with the steps the user could take to remediate. These insights are applied on entities such as employee, identity, connection, permission, resource and role.
8. Action: Users can choose to take action on their findings by creating access requests, access review campaigns, purposes and converting roles to purposes using natural language on the copilot. This will allow for users to perform provisioning and deprovisioning of accesses as required.

Using the generated query, the desired results are obtained from the knowledge graph. Based on the results, users can ask follow-up informational questions. Users can also choose to perform analysis, like finding similar nodes for migration of employees between teams and link prediction to find missing connections. This is achieved by leveraging graph neural networks. Furthermore, actions like creating access requests, access review campaigns, provisioning and de-provisioning of users using purposes can be performed as well by simply utilizing natural language.

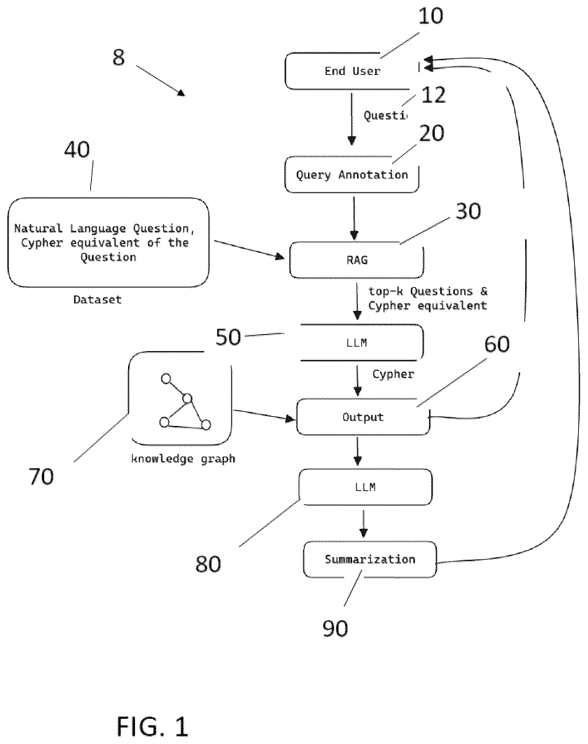

FIG. 1 shows a diagram 100 for use of the platform for users to manage and understand access within an organization. Employees and administrators often seek answers to critical questions such as who has access to what, how that access was granted, and when it was established. The Employees and administrators need to identify whether sensitive resources are being accessed, if terminated employees still retain access, and who has or hasn't undergone necessary reviews. Once these questions are addressed, users may need to escalate findings in reports or create dashboards for ongoing monitoring. Since accessing this information requires familiarity with complex query languages, posing a significant barrier the platform is provided to give users the ability to discover and investigate their data without being constrained by technical skills.

The platform is a system that leverages a knowledge graph 70 and Large Language Models 50, 80 (LLMs). Access data is structured within the knowledge graph 70 as nodes and relationships. Users 10 can ask questions 12 in natural language, which are then transformed into graph-compatible queries 20 through the combined use of Retrieval-Augmented Generation (RAG) 30 and LLMs 50, 80. RAG 30 retrieves relevant context from a query dataset 40, ensuring the LLM 50 generates an accurate and contextually appropriate query output 60 based on the user's input and the knowledge graph schema 70. The 20 query is then used to retrieve the necessary data, which is summarized 90 for the end user, making the data easy to interpret and act upon.

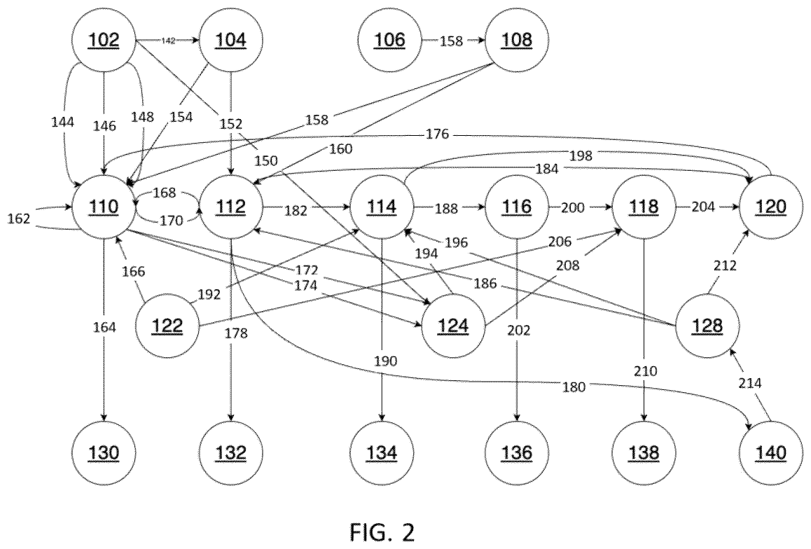

As shown in FIG. 2 the identity intelligence graph 100 is a knowledge graph and is a structured representation of information that organizes data in a graph-like format. Entities are represented as nodes and their relationships are captured as edges. The identity intelligence graph 200 may be developed in-house to an organization wherein the identity intelligence graph organizes identity security information as a knowledge graph. Each node in the graph corresponds to an entity, such as an employee, identity, connection, or resource, and can contain attributes that describe its properties. Similarly, edges represent the relationships between these entities, detailing how they relate to one another. Both nodes and edges can have additional attributes, allowing the knowledge graph to provide a rich, contextual understanding of complex data, making it easier to query and analyze. In the context of an identity access management dataset, the data is centered around the concept of identity.

As an example, an employee has an identity to access various applications. These identities are linked to resources within an application through connections. A connection consists of a set of permissions. Each of these entities (identities, employees, connections, resources, permissions) can have multiple insights. For instance: A permission might have an insight “privileged” if it grants administrative access. An identity might be labeled as “over-entitled” if it has access to resources that are not typical for its peer group.

A breakdown of the identity intelligence graph & the list of the nodes, edges & relationships is listed herein. Nodes as shown in FIG. 1 and their attributes include:
1. Identity 112
   handle (String)
   identity_id (String)
   identity_type (String)
2. Employee 110
   department (String)
   email (String)
   employee_id (String)
   employment_type (String)
   end_date (String)
   job_title (String)
   name (String)
   start_date (String)
3. Application 120
   application_id (String)
   description (String)
   last_synced (String)
   name (String)
   project (String)
4. Connection 114
   connection_id (String)
   name (String)
   provider (String)
   provider_type (String)
   type (String)
5. Resource 118
   app (String)
   name (String)
   resource_id (String)
   type (String)
6. Permission 116
   name (String)
   permission_id (String)
   value (String)
7. EmployeeInsight 130
   description (String)
   insight_id (String)
   insight_name (String)
   insight_type (String)
   label (String)
   mitigations (String)
   source (String)
8. IdentityInsight 132
   description (String)
   filters (String)
   insight_id (String)
   insight_name (String)
   insight_type (String)
   label (String)
   logic (String)
   query (String)
   mitigations (String)
   source (String)
   rule_attributes (StringArray)
   rule_platform_id (String)
   severity (String)
9. ConnectionInsight 134
   description (String)
   insight_id (String)
   insight_name (String)
   insight_type (String)
   label (String)
   mitigations (String)
   severity (String)
   source (String)
10. PermissionInsight 136
   description (String)
   insight_id (String)
   insight_name (String)
   insight_type (String)
   label (String)
   mitigations (String)
   source (String)
11. ResourceInsight 138
   description (String)
   insight_id (String)
   insight_name (String)
   insight_type (String)
   label (String)
   mitigation (String)
   source (String)
12. RBACInsight 140
   description (String)
   insight_id (String)
   insight_name (String)
   insight_type (String)
   label (String)
   mitigation (String)
   source (String)
13. Campaign 106
   campaign_id (String)
   description (String)
   end_date (String)
   is_published (String)
   name (String)
   percentage_completed (String)
   start_date (String)
   status (String)
14. Request 102 expiration_date (String)
   request_id (String)
   request_type (String)
15. RequestReview 104
   creation_date (String)
   original_id (String)
   review_application_description (String)
   review_application_integration_id (String)
   review_application_name (String)
   review_connection (String)
   review_connection_type (String)
   review_id (String)
   review_insights (StringArray)
   review_permission_name (String)
   review_permission_value (String)
   review_resource_name (String)
   review_resource_type (String)
   review_status (String)
   review_type (String)
16. Review 108
   creation_date (String)
   original_id (String)
   review_application_description (String)
   review_application_integration_id (String)
   review_application_name (String)
   review_connection (String)
   review_connection_type (String)
   review_id (String)
   review_insights (StringArray)
   review_permission_name (String)
   review_permission_value (String)
   review_resource_name (String)
   review_resource_type (String)
   review_status (String)
   review_type (String)
17. Role 128
   name (String)
   role_id (String)
   type (String)
18. Purpose 122
   name (String)
   purpose_id (String)
   created_timestamp (String)
   updated_timestamp (String)
   employee_filter (String)
19. Constraint 124
   name (String)
   constraint_id (String)
   created_timestamp (String)
   employee_filter (String)
20. Relationships as shown in edges of FIG. 1.:
   (:Application)-[:APP_HAS_PRIMARY_OWNER]->(:Employee) 176
   (:Campaign)-[:CAMPAIGN_HAS_REVIEW]->(:Review) 156
   (:Connection)-[:CONNECTION_HAS_APP]->(:Application) 198
   (:Connection)-[:CONNECTION_HAS_INSIGHT]->(:ConnectionInsight) 190
   (:Connection)-[:CONNECTION_HAS_PERMISSION]->(:Permission) 188
   (:Constraint)-[:CONSTRAINT_CONSTRAINS_EMPLOYEE]->(:Employee) 166
   (:Constraint)-[:CONSTRAINT_HAS_CONNECTION]->(:Connection) 192
   (:Constraint)-[:CONSTRAINT_HAS_RESOURCE]->(:Resource) 206
   (:Employee)-[:EMPLOYEE_HAS_INSIGHT]->(:EmployeeInsight) 164
   (:Employee)-[:HAS_IDENTITY]->(:Identity) 168
   (:Employee)-[:EMPLOYEE_IS_ELIGIBLE_FOR_PURPOSE]->(:Purpose)
   (:Employee)-[:EMPLOYEE_IS_ASSIGNED_PURPOSE]->(:Purpose) 174
   (:Employee)-[:MANAGES]->(:Employee) 162
   (:Identity)-[:IDENTITY_HAS_APP]->(:Application) 184
   (:Identity)-[:IDENTITY_HAS_CONNECTION]->(:Connection) 182
   (:Identity)-[:IDENTITY_HAS_INSIGHT]->(:IdentityInsight) 178
   (:Identity)-[:IDENTITY_HAS_INSIGHT]->(:RBACInsight) 180
   (:Identity)-[:IDENTITY_OF]->(:Employee) 170
   (:Permission)-[:GRANTS_PERMISSION_TO_RESOURCE]->(:Resource) 200
   (:Permission)-[:PERMISSION_HAS_INSIGHT]->(:PermissionInsight) 202
   (:Purpose)-[:PURPOSE_HAS_CONNECTION]->(:Connection) 194
   (:Purpose)-[:PURPOSE_HAS_RESOURCE]->(:Resource) 208
   (:RBACInsight)-[:INSIGHT_BASED_ON_ROLE]->(:Role) 214
   (:Request)-[:REFERENCES]->(:Employee) 148
   (:Request)-[:REQUEST_CREATED_BY]->(:Employee) 144
   (:Request)-[:REQUEST_FOR_REVIEW]->(:RequestReview) 142
   (:Request)-[:REQUEST_FOR_PURPOSE]->(:Purpose) 150
   (:Request)-[:REQUEST_TARGETS_EMPLOYEE]->(:Employee) 146
   (:RequestReview)-[:ASSIGNED_TO_EMPLOYEE]->(:Employee) 154
   (:RequestReview)-[:REVIEW_ON_IDENTITY]->(:Identity) 152
   (:Resource)-[:RESOURCE_BELONGS_TO_APP]->(:Application) 204
   (:Resource)-[:RESOURCE_HAS_INSIGHT]->(:ResourceInsight) 210
   (:Review)-[:ASSIGNED_TO_EMPLOYEE]->(:Employee) 158
   (:Review)-[:REVIEW_ON_IDENTITY]->(:Identity) 160
   (:Role)-[:ROLE_ASSIGNED_TO_IDENTITY]->(:Identity) 186
   (:Role)-[:ROLE_BASED_ON_CONNECTION]->(:Connection) 196
   (:Role)-[:ROLE_BELONGS_TO_APP]->(:Application) 212

By organizing these entities and their attributes as described above, the identity intelligence graph can be easily understood, queried, and analyzed to extract valuable insights.

To retrieve data accurately from the knowledge graph, user queries are annotated to ensure entities are correctly identified. This step is essential for extracting the right information, as it involves distinguishing between different types of entities, verifying their correctness, and understanding the context in which they are mentioned. For example, if a user queries “List all the terminated employees,” the intent is clear-there is no reference to a specific employee or application. In this case, the query can be directly executed against the knowledge graph without needing further clarification.

The complexity increases with queries like “List all the connections for AWS.”. In this case, the user is asking specifically about an application, “Amazon Web Services,” which requires a precise identification of the term in the knowledge graph. The challenge arises because the application could be represented in the data under different names, such as “Amazon,” AWS,” or “Amazon Web Services.” If the data uses the name “Amazon Web Services” a direct query like: MATCH (a:Application {name: “AWS”})<-[:CONNECTION_HAS_APP]-(c:Connection) RETURN c will not return the correct results due to the mismatch in entity names. To handle variations in names—such as abbreviations, alternative spellings, case differences, and even common misspellings—we introduced a more sophisticated annotation process.

To perform the annotation, the EntityRuler, a component of the spaCy natural language processing (NLP) library, may be used. The Entity Ruler enables pattern-based entity recognition by defining patterns that match tokens or phrases representing various entities, such as names, connections, or resource names.

To further improve detection of proper entities, the platform includes a system of @mentions for entities. @Mentions are a way of tagging or directly referencing a specific entity within the text, similar to how platforms like Jira allow users to mention specific employees (e.g., @employee_name). In context as outlined herein, every entity in the knowledge graph can be referred to with an @mention, ensuring consistent and clear identification across all queries. This approach eliminates ambiguity and ensures that entities are consistently matched to their correct forms in the knowledge graph.

Introducing these @mentions and pattern-based annotations functions to significantly improve the system's accuracy in recognizing entities and processing queries correctly.

RAG stands for Retrieval-Augmented Generation. It is a method used in natural language processing (NLP) that combines retrieval-based and generative approaches to improve the quality and accuracy of generated responses. RAG is particularly useful when the information needed to answer a query is not contained within the model itself but can be found in external sources. This approach enables large language models (LLMs) to perform better on tasks that require domain-specific knowledge.

The platform uses state-of-the-art LLM models to convert natural language queries into Cypher queries, enabling users to interact with a knowledge graph intuitively. While LLMs are highly versatile and pre-trained on vast amounts of data across diverse topics, they can sometimes generate inaccurate or irrelevant responses, particularly in highly specific or domain-centric contexts—a phenomenon known as hallucination.

To address this challenge and improve the accuracy of the queries generated by the LLM, the platform adopts a few-shot learning approach. By providing the LLM with a curated set of domain-specific examples, the platform enables it to better understand the nuances of the use case, resulting in more precise query generation and a significant reduction in hallucinations.

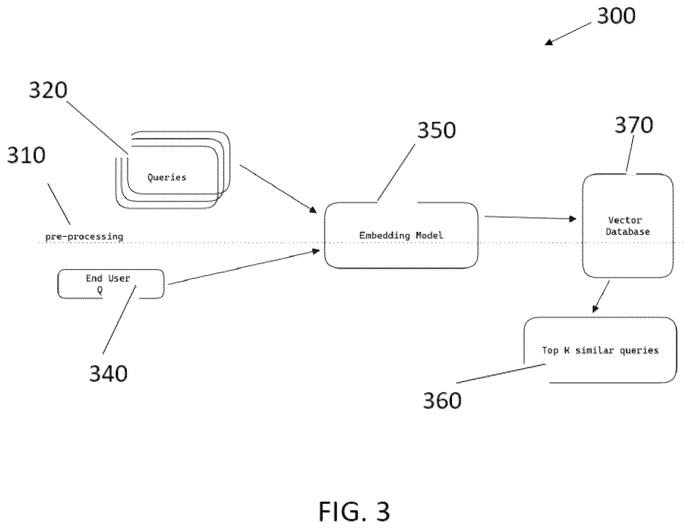

As shown in FIG. 3, the steps 300 include pre-processing 310 wherein a dataset 370 is developed containing user queries 320 in natural language paired with their corresponding cypher queries 340. Using an embedding model 350, embedding transforms the queries into a high-dimensional vector space. The embeddings are stored in a vector store for efficient retrieval. In query handling. When a user poses a question, it is transformed into the same embedding space as the pre-processed dataset. The system then identifies the top-K queries 360 from the vector store that are most similar to the user's question.

To implement few-shot learning in the system, the example databank is transformed into high-dimensional vector representations through state-of-the-art embedding models. These embeddings were stored in a vector store, which acts as a searchable database, allowing for rapid retrieval and comparison based on vector proximity. When a user poses a question, the system transforms it into the same embedding space, ensuring compatibility with the stored embeddings. The transformed query is compared against the vector store to identify the top 5 most similar queries, which are retrieved based on their semantic content. These relevant examples guide the LLM in generating an accurate Cypher query that aligns with the user's intent, reducing the likelihood of hallucinations and enhancing the system's reliability.

RAG is used to augment the copilot platform with relevant information from the knowledge base dataset when a user asks descriptive questions about Identity Security or ID-specific concepts. This allows the user to engage in a cohesive, free flowing conversation with the copilot.

Large Language Models (LLMs) are powerful AI tools trained on a wide range of data to understand, generate, and manipulate human language in meaningful ways. Their ability to grasp complex language patterns, semantics, and context allows them to excel in tasks like text generation, translation, summarization, and question-answering.

Cypher Query generation via LLM for the specific use case as outlined herein, the platform leverages state-of-the art LLM models to translate natural language queries into Cypher queries. These models, rooted in deep learning architecture, use the Transformer architecture as its backbone. While LLMs are pre-trained on diverse datasets like articles, books, and websites, they still require domain-specific knowledge to deliver accurate results.

To train the LLM to meet requirements, it is provided a focused dataset, which includes cypher queries retrieved by RAG (Retrieval-Augmented Generation) which provides the model with examples of well-formed Cypher queries relevant to the platform domain. The focused dataset includes a knowledge graph schema having a detailed schema of a graph database, the graph database including the entities, nodes, relationships, and attributes, and ensuring the model understands the underlying data structure. The focused dataset includes natural language queries including end user queries. By combining the cypher queries, knowledge graph schema and natural language queries, the LLM better understands the specific domain context and improve its ability to translate natural language queries into Cypher queries effectively.

To further refine the model's accuracy, the platform implements strategies like Hyperparameter Tuning: Adjusting parameters such as temperature to control the randomness of the outputs, thus balancing between creativity and precision. Lower temperatures made the model more deterministic, ensuring that the generated cypher queries were consistently accurate.

Adopting an Agentic Framework: This framework allowed us to better guide the model's behavior, optimizing it for the broader task of planning, answering, reporting and acting on questions of the end user on their organization's identity security posture in a free flowing conversation. The framework helped prioritize accuracy and contextual relevance, making the model more effective in breaking down the user's input into relevant tool calls and responding appropriately. Additionally, error correction was crucial to improving the reliability of the generated Cypher queries. The platform establishes several checks and validation mechanisms including:
1. Node Name Hallucination Prevention. Node Name Hallucination Prevention ensures that the model does not generate or refer to non-existent nodes in the database. Incorrect Relationships Between Nodes: Validating that the relationships suggested by the model are logically and contextually accurate, based on the graph schema.
2. LLM Repeat Tries. Setting up a mechanism for iterative attempts, where the model retries generating a query if initial attempts do not meet predefined accuracy thresholds.

By implementing these strategies, the platform significantly reduces errors and improved the quality and reliability of the generated Cypher queries.

Leveraging state-of-the-art LLMs for converting natural language to Cypher queries is a transformative approach that broadens access to data stored in graph databases. It enables users to interact directly with complex datasets, obtain insights faster, and make data-driven decisions more efficiently. By fine-tuning the model with domain-specific data, optimizing its performance, and implementing strong error-checking mechanisms, the platform is a robust system that bridges the gap between human language and technical database queries, ultimately driving more effective and accessible data analysis.

Summarizing using LLM-After retrieving data using the Cypher query, the platform summarizes it to enable quick understanding and to prioritize security-related insights when needed. To do this, the raw data is converted into a set of meaningful metrics. For example, if the data includes information about connections and resources associated with a particular application, it is presented to the language model (LLM) in a structured format such as “10 AmazonEC2ContainerRegistryPowerUser connections,” “5 AmazonEKSServicePolicy connections,” and “2 lambda resource types,” along with the user's original query in an obfuscated manner. This input enables the LLM to generate a concise and relevant summary.

This approach provides users with actionable and concise insights while protecting against sharing sensitive data with the LLM. By focusing only on the essential metrics and related questions, the platform ensures that the LLM generates a summary that is both accurate and context-appropriate.

Security findings are central to discovery on the copilot platform. Security findings include are primarily of 4 types: Rule based like SoD, Privileged connection/permission and Sensitive resource that are defined within the Application by the user; HRIS based like Terminated and Manager that are fetched from the organization's HRIS system; Application based like MFA Missing and Unused Access Key that are extracted using the application's security/risk APIs; and RBAC based like Overentitled and Outlier that are derived using an RBAC Analyser.

These insights are applied at the employee, identity, connection, permission, role and resource level. These security findings must be flagged and highlighted to the user even when not asked for specifically. This guides the user to more fruitful discovery. Security findings are integrated into the copilot in the following ways: When cypher queries are generated for natural language questions, they are altered using a custom algorithm to ensure that insights relevant to the user's questions are returned; The summary flags key security findings thereby drawing the user's attention; and all security insights can be further explored at the tenant level by clicking on them, providing context-specific explanations along with summary statistics relevant to the tenant.

Users can leverage this system to create dynamic reports and interactive dashboards through a seamless and intuitive process. The process involves several steps. First is query formulation: Users begin by posing natural language questions to the system. For instance, a user might ask, “Show me the top 10 users with the highest number of security violations.” The second is iterative query refinement: whereby users interact with the system and receive real-time feedback and can refine their queries iteratively. For example, if the initial query returns too much data or not enough detail, users can adjust their questions or specify additional criteria to narrow down the results. The third is data retrieval and summarization where, based on the refined queries, the system retrieves relevant data from the knowledge graph using cypher queries. This data is then summarized into key metrics and insights, which are presented in a concise format. Users can review these summaries to ensure their needs are met. The fourth is report generation whereby once users are satisfied with the summarized data, the LLM can assist in generating detailed reports based on previous queries.

This involves selecting relevant metrics and visualizations, such as charts or tables, and organizing them into a structured report format. The LLM can further customize the report by adding titles, descriptions, and annotations to highlight important findings. The fifth is dashboard creation for more interactive and real-time analysis. The LLM can help users create dashboards based on previous queries. The LLM can combine multiple visualizations and metrics into a single, interactive view by selecting from various widgets, such as graphs, tables, and heat maps, to display different aspects of the data. Dashboards can be configured to update in real-time as new data becomes available, ensuring continuous insights. The sixth is sharing and collaboration where, once created, reports and dashboards can be shared with other stakeholders or teams. Users can export reports in various formats (e.g., PDF, Excel) and share dashboards through secure links or embedded views. This facilitates collaboration and ensures that insights are accessible to those who need them. By following these steps, users can effectively transform their queries into actionable insights, creating reports and dashboards that enhance decision-making and strategic planning capabilities. This process not only provides a flexible and user-friendly approach to data analysis but also ensures that users can adapt and refine their outputs as their needs evolve.

The copilot platform empowers end users to interact with their data using natural language, removing the need for specialized query languages. The identity intelligence graph organizes identity security data as a knowledge graph, thereby capturing its complexity and relatedness. By integrating knowledge graphs with LLMs, the platform seamlessly converts user queries into knowledge graph-based queries through RAG and LLMs. To support informed decision-making, the platform provides concise summaries of the requested data using LLM. The queries generated by this process also enable the creation of custom reports and dashboards that dynamically respond to evolving user needs. Additionally, with each query, users receive security insights, ensuring they are aware of any potential concerns and can take proactive measures to address them, safeguarding against overlooked security issues.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various disk drives (HDD, SSD), CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A platform for allowing users to proactively manage user identity data and user identity risks, the platform comprising:
an identity knowledge graph for enabling a user to visualize relationships between identities of the user, connections, resources and applications, the identity knowledge graph including a plurality of nodes wherein the plurality of nodes are selected from a group including:
Identity;
Employee;
Application;
Connection;
Resource;
Permission;
EmployeeInsight;
IdentityInsight;
ConnectionInsight;
PermissionInsight;
ResourceInsight;
RBACInsight;
Campaign;
Request;
RequestReview;
Review;
Role;
Purpose; and
Constraint
wherein insights are intelligently routed, assessed, and remediated based on AI playbooks to meet identity and access lifecycle, technology compliance, and risk management needs; and
wherein the platform includes a system leveraging a knowledge graph and Large Language Models wherein access data is structured within the knowledge graph as nodes and relationships.

2. The platform of claim 1 wherein the user can ask questions in natural language, wherein the questions are transformed into graph-compatible queries through combined use of Retrieval-Augmented Generation (RAG) and LLMs wherein RAG retrieves relevant context from a query dataset, ensuring the Large Language Model generates an accurate and contextually appropriate query based on user input and knowledge graph schema.

3. The platform of claim 2 wherein the query is used to retrieve necessary data, which is summarized for the user, making data easy to interpret and act upon.

4. A copilot for identity security, the copilot having AI-assistance and including:
a Large Language Model for converting natural language to graph queries, wherein a knowledge graph schema of the copilot provides Large Language Model information on structure nodes, relations and attributes in the knowledge graphs so queries can be formed adhering to the graph structure;
based on a question, the platform retrieves similar question and graph query pairs based on cosine similarity;
an error correction module whereby errors in graph query execution are fed back to the Large Language Model with error messages to retry generation;
a human feedback module whereby correctness of output is collected to improve Large Language Model generation;
an entity tagging module whereby entities are tagged using fuzzy search to recognize known entities and their types based on the knowledge graph;
a summary module where, based on data fetched to answer a given question, the platform generates a summary without passing personally identifiable information to the Large Language Model;
a suggestions module that recommends follow-up questions for the user to deepen their analysis based on the context of the conversation; and
predefined use cases, consisting of a series of sequential questions, which users can follow to comprehensively analyze specific aspects of their organization's identity security posture.

5. The copilot of claim 4 wherein insights like ‘Terminated’, ‘Manager’, ‘Privileged Permission’, ‘Privileged Connection’, ‘SoD’, ‘Overentitled’, ‘Outlier’, ‘MFA Missing’, ‘Unused Credentials’, ‘Data Exfiltration’, ‘Admin IAM Policy’, ‘Root Account Access’ and ‘Stale Access Keys’ may be implemented with varying severity levels. Based on these insights, the platform uses an LLM to explain the existence of the insight along with the steps the user could take to remediate.

6. The copilot of claim 4 wherein using the generated query, the desired results are obtained from the knowledge graph and based on the results, users can ask follow-up informational questions.

7. The copilot of claim 4 wherein the user can choose to perform analysis, like finding similar nodes for migration of employees between teams and link prediction to find missing connections, which is achieved by leveraging graph neural networks.

8. The copilot of claim 4 wherein actions like creating access requests, access review campaigns, provisioning and de-provisioning of users using puposes can be performed as well by simply utilizing natural language.

9. The copilot of claim 4 wherein the copilot utilizes relational and connected nature of knowledge graphs.

10. The copilot of claim 4 wherein the copilot employs AI agents to allow clients to interact, analyze and act on their identity security data using natural language.

11. The copilot of claim 4 including integrating knowledge graphs, the copilot provides flexibility in structure, scalability, easy interpretation, and eliminates redundancy.

12. The copilot of claim 4 wherein the copilot utilizes the agentic behavior of large language models to break down a complex question into a series of subtasks.

13. The copilot for identity security of claim 4 wherein the summary module, wherein insights like ‘Terminated’, ‘Manager’, ‘Privileged Permission’, ‘Privileged Connection’, ‘SoD’, ‘Overentitled’, ‘Outlier’, ‘MFA Missing’, ‘Unused Credentials’, ‘Data Exfiltration’, ‘Admin IAM Policy’, ‘Root Account Access’ and ‘Stale Access Keys’ are fetched along with the data at the permission, resource, role, connection, identity and employee level and is brought to the attention of the user.

14. The copilot for identity security of claim 13 wherein the insights are implemented based on a combination of filters and based on the information, the platform uses an LLM to explain the existence of the insight along with the steps the user could take to remediate it.

15. The copilot for identity security of claim 4 including using the generated query to obtain results from the knowledge graph wherein, based on the results, users can ask follow-up informational questions and also provided a choice to perform analysis, like finding similar nodes for migration of employees between teams and link prediction to find missing connections.

16. The copilot for identity security of claim 15 wherein graph neural networks are used and actions such as creating access review campaigns, provisioning and de-provisioning of users are performed using natural language.

17. A copilot platform for identity security governance and lifecycle management, the copilot platform comprising:
the copilot platform for capturing the relatedness of identity security data;
wherein the copilot platform integrates Knowledge Graphs and a Large Language Model to enhance data exploration and understanding;
wherein the Large Language Model converts natural language queries into Cypher queries, enabling seamless interaction with graph databases;
query annotation to facilitate Large Language Model for recognized entities and for enduring necessary correctness to those entities if required and that increases overall accuracy of the Copilot;
wherein the Large Language Model and data metrics are used to summarize the data for the user.

18. The copilot platform of claim 17 including the copilot platform using an AI system for interacting with a user wherein the AI system can interact with the user to learn more about a state of user identity security and take action when required and, given the complexity of IGA data, including information on differentiated dashboards and custom reports for allowing the user to visualize and manage the information effectively.
